(19) United States
(12) Patent Application Publication
(10) Pub. No.: US 2026/0005779 A1
(43) Pub. Date: Jan. 1, 2026

(54) MEDIUM ACCESS CONTROL CONTROL ELEMENT FOR REPORTING INTERFERENCE

(71) Applicant: QUALCOMM INCORPORATED, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ruiming ZHENG, Beijing (CN); Seyedkianoush HOSSEINI, San Diego, CA (US); Ahmed Attia ABOTABL, San Diego, CA (US); Huilin XU, Temecula, CA (US)

(21) Appl. No.: 18/880,724

(22) PCT Filed: Aug. 19, 2022
(86) PCT No.: PCT/CN2022/113532

§ 371 Date: Jan. 2, 2025

(51) Int. Cl. H04B 17/309; H04L 41/16; H04W 80/02

(52) U.S. Cl. CPC H04B 17/346; H04L 41/16; H04W 80/02

(57) ABSTRACT

Various aspects of the present disclosure generally relate to wireless communication. In some aspects, a user equipment (UE) may generate a medium access control control element (MAC CE) that includes one or more reports that each indicate one or more cross-link interference or self-interference values. The UE may transmit the MAC CE. Numerous other aspects are described.

### FIELD OF THE DISCLOSURE

Aspects of the present disclosure generally relate to wireless communication and specifically to techniques and apparatuses for reporting cross-link interference or self-link interference.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include generating a medium access control control element (MAC CE) that includes one or more reports that each indicate one or more cross-link interference (CLI) or self-interference (SI) values. The method may include transmitting the MAC CE.

Some aspects described herein relate to a method of wireless communication performed by a network entity. The method may include transmitting a configuration of resources for CLI or SI measurement. The method may include receiving a MAC CE that includes one or more reports that each indicate one or more CLI or SI values.

Some aspects described herein relate to a UE for wireless communication. The UE may include a memory and one or more processors coupled to the memory. The one or more processors may be configured to generate a MAC CE that includes one or more reports that each indicate one or more CLI or SI values. The one or more processors may be configured to transmit the MAC CE.

Some aspects described herein relate to a network entity for wireless communication. The network entity may include a memory and one or more processors coupled to the memory. The one or more processors may be configured to transmit a configuration of resources for CLI or SI measurement. The one or more processors may be configured to receive a MAC CE that includes one or more reports that each indicate one or more CLI or SI values.

Some aspects described herein relate to a non-transitory computer-readable medium that stores a set of instructions for wireless communication by a UE. The set of instructions, when executed by one or more processors of the UE, may cause the UE to generate a MAC CE that includes one or more reports that each indicate one or more CLI or SI values. The set of instructions, when executed by one or more processors of the UE, may cause the UE to transmit the MAC CE.

Some aspects described herein relate to a non-transitory computer-readable medium that stores a set of instructions for wireless communication by a network entity. The set of instructions, when executed by one or more processors of the network entity, may cause the network entity to transmit a configuration of resources for CLI or SI measurement. The set of instructions, when executed by one or more processors of the network entity, may cause the network entity to receive a MAC CE that includes one or more reports that each indicate one or more CLI or SI values.

Some aspects described herein relate to an apparatus for wireless communication. The apparatus may include means for generating a MAC CE that includes one or more reports that each indicate one or more CLI or SI values. The apparatus may include means for transmitting the MAC CE.

Some aspects described herein relate to an apparatus for wireless communication. The apparatus may include means for transmitting a configuration of resources for CLI or SI measurement. The apparatus may include means for receiving a MAC CE that includes one or more reports that each indicate one or more CLI or SI values.

Aspects generally include a method, apparatus, system, computer program product, non-transitory computer-readable medium, UE, base station, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example disaggregated base station architecture, in accordance with the present disclosure.

FIGS. 4A-4C are diagrams illustrating examples of full-duplex communication in accordance with the present disclosure.

FIG. 5 is a diagram illustrating an example of full-duplex communication modes, in accordance with the present disclosure.

FIG. 6 is a diagram illustrating examples of full-duplex communication, in accordance with the present disclosure.

FIG. 7 is a diagram illustrating an example of cross-link interference or self-interference reporting, in accordance with the present disclosure.

FIG. 8 is a diagram illustrating examples of medium access control control element (MAC CE) designs, in accordance with the present disclosure.

FIG. 9 is a diagram illustrating examples of MAC CE designs, in accordance with the present disclosure.

FIG. 10 is a diagram illustrating an example of measurement resources, in accordance with the present disclosure.

FIG. 11 is a diagram illustrating examples of MAC CE designs, in accordance with the present disclosure.

FIG. 12 is a diagram illustrating examples of MAC CE designs, in accordance with the present disclosure.

FIG. 13 is a diagram illustrating examples of MAC CE designs, in accordance with the present disclosure.

FIG. 14 is a diagram illustrating an example process performed, for example, by a UE, in accordance with the present disclosure.

FIG. 15 is a diagram illustrating an example process performed, for example, by a network entity, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

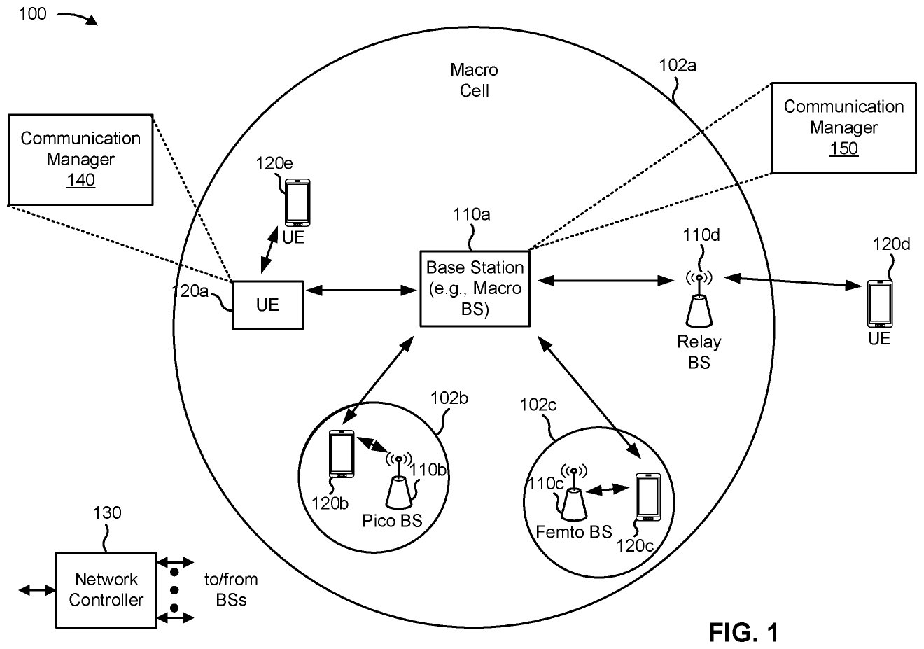

FIG. 1 is a diagram illustrating an example of a wireless network in accordance with the present disclosure. The wireless network 100 may be or may include elements of a 5G (e.g., NR) network or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some aspects, the term “base station” (e.g., the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move in accordance with the location of a base station 110 that is mobile (e.g., a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (e.g., a remote device), or some other entity. Some UEs 120 may be considered Internet-of-Things (IOT) devices, or may be implemented as NB-IOT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (e.g., one or more processors) and the memory components (e.g., a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHz). It should be understood that although a portion of FR1 is greater than 6 GHz, FRI is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (e.g., FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may generate a medium access control control element (MAC CE) that includes one or more reports that each indicate one or more cross-link interference (CLI) or self-interference (SI) values and transmit the MAC CE. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a configuration of resources for CLI or SI measurement. The communication manager 150 may receive a MAC CE that includes one or more reports that each indicate one or more CLI or SI values. Additionally, or alternatively, the communication manager 150 may perform one or more other operations described herein.

As indicated above, FIG. 1 is provided as an example. Other examples may differ from what is described with regard to FIG. 1.

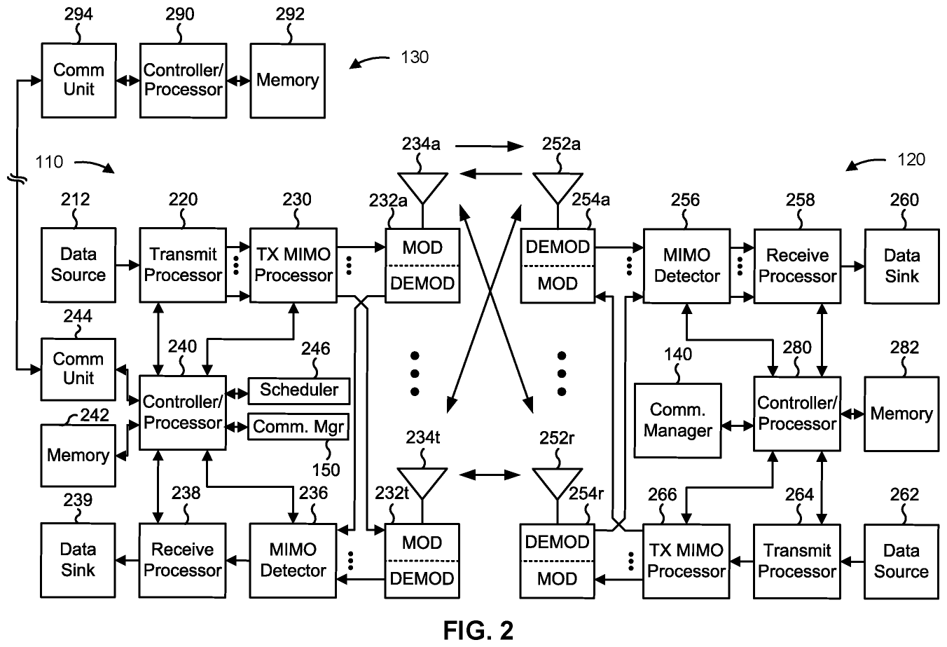

FIG. 2 is a diagram illustrating an example base station 110 in communication with a UE 120 in a wireless network in accordance with the present disclosure. The base station 110 may correspond to the base station 110 of FIG. 1. Similarly, the UE 120 may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (e.g., for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (e.g., the controller/processor 280) and the memory 282 to perform aspects of any of the methods described herein.

At the base station 110, the uplink signals from UE 120 or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (e.g., the controller/processor 240) and the memory 242 to perform aspects of any of the methods described herein.

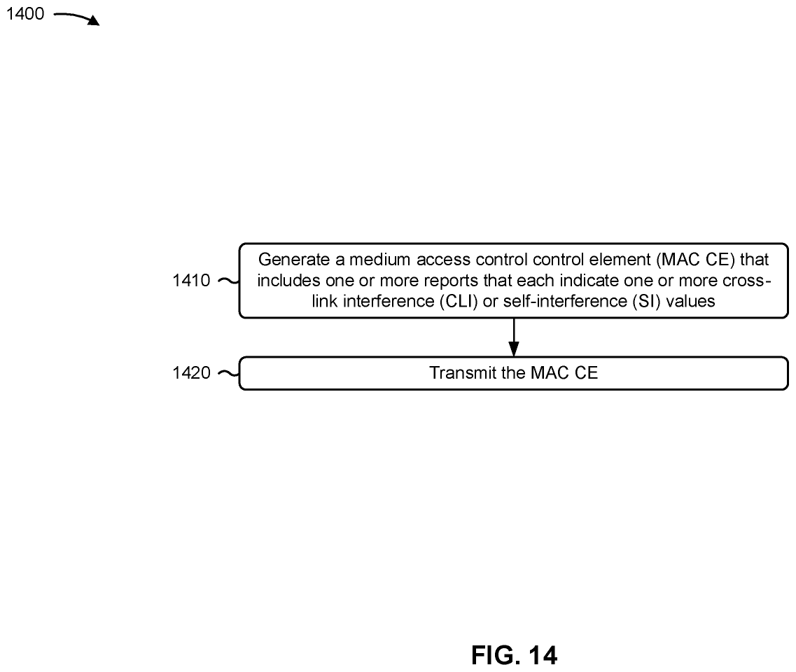

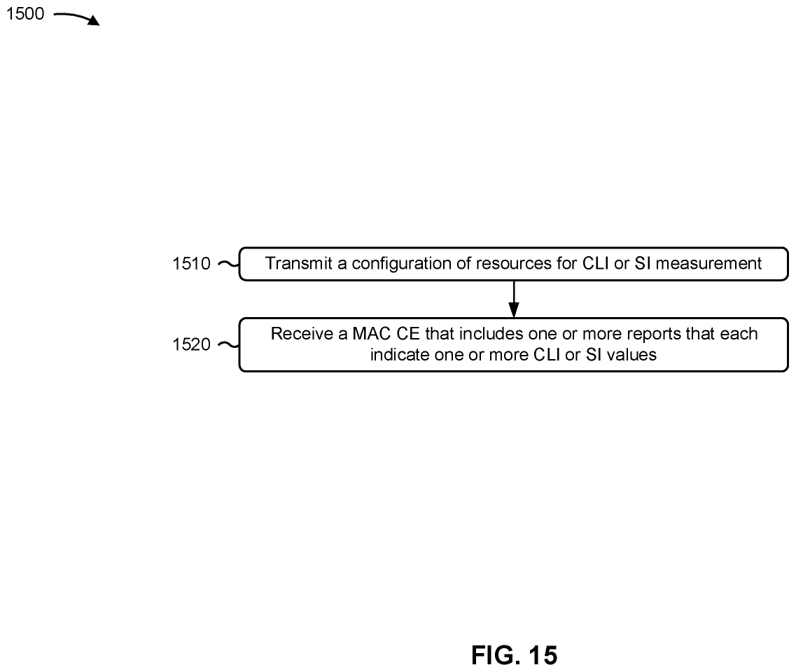

The controller/processor of a network entity (e.g., controller/processor 240 of the base station 110), the controller/processor 280 of the UE 120, or any other component(s) of FIG. 2 may perform one or more techniques associated with reporting CLI or SI via a MAC CE, as described in more detail elsewhere herein. For example, the controller/processor 240 of the base station 110, the controller/processor 280 of the UE 120, or any other component(s) of FIG. 2 may perform or direct operations of, for example, process 1400 of FIG. 14, process 1500 of FIG. 15, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (e.g., code or program code) for wireless communication. For example, the one or more instructions, when executed (e.g., directly, or after compiling, converting, or interpreting) by one or more processors of the base station 110 or the UE 120, may cause the one or more processors, the UE 120, or the base station 110 to perform or direct operations of, for example, process 1400 of FIG. 14, process 1500 of FIG. 15, or other processes as described herein. In some examples, executing instructions may include running the instructions, converting the instructions, compiling the instructions, or interpreting the instructions, among other examples.

In some aspects, the UE 120 includes means for generating a MAC CE that includes one or more reports that each indicate one or more CLI or SI values; and/or means for transmitting the MAC CE. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting a configuration of resources for CLI or SI measurement; and/or means for receiving a MAC CE that includes one or more reports that each indicate one or more CLI or SI values. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (e.g., within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As indicated above, FIG. 2 is provided as an example. Other examples may differ from what is described with regard to FIG. 2.

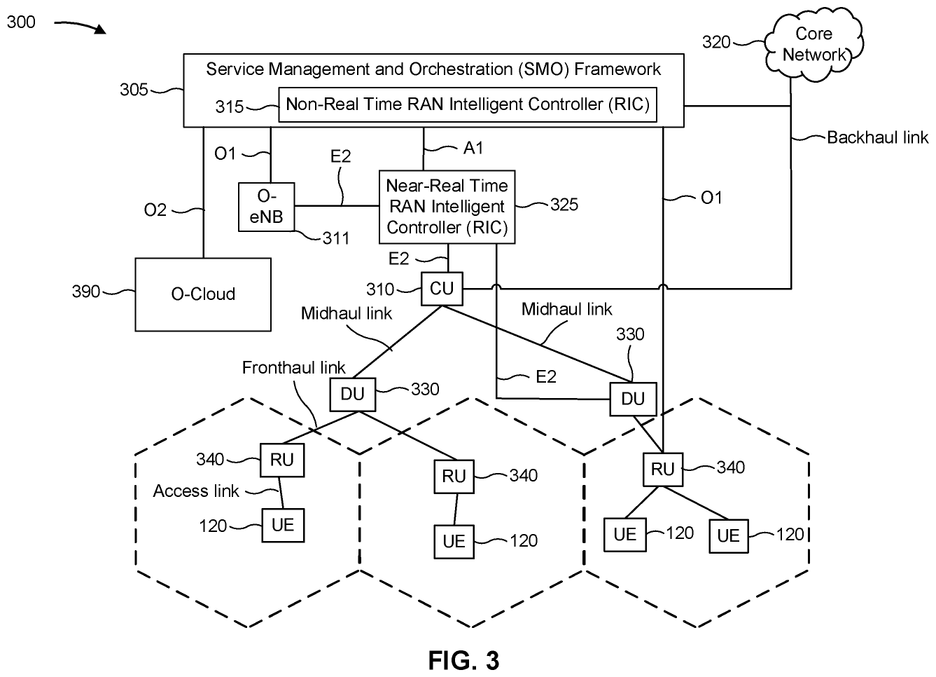

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (e.g., Central Unit-User Plane (CU-UP) functionality), control plane functionality (e.g., Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based at least in part on a functional split (e.g., a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

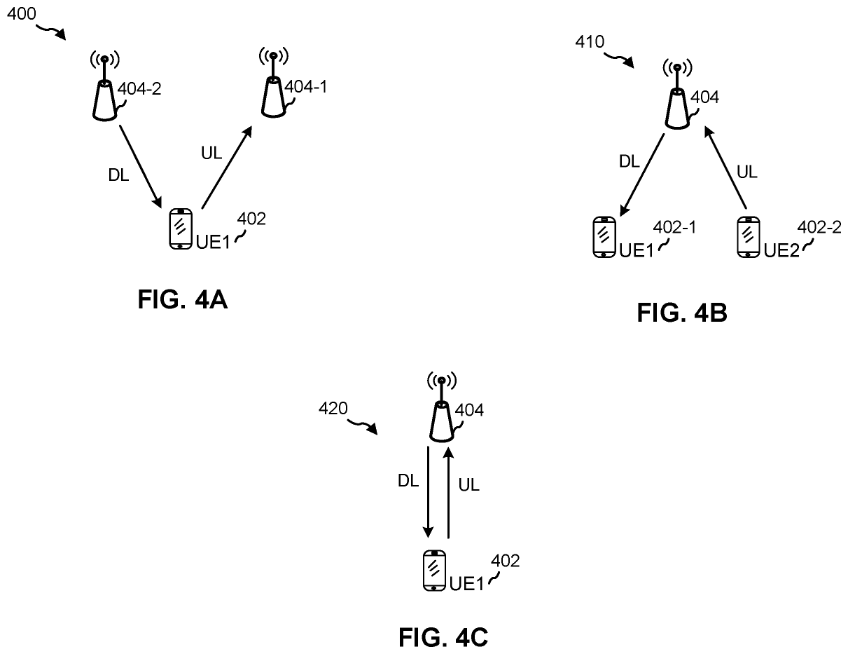

FIGS. 4A-4C are diagrams illustrating examples of full-duplex (FD) communication in accordance with the present disclosure. A first full-duplex scenario 400 depicted in FIG. 4A includes a UE1 402 and two base stations (e.g., network entities or TRPs) 404-1, 404-2, where the UE1 402 is sending uplink transmissions to base station 404-1 and is receiving downlink transmissions from base station 404-2. In the first full-duplex scenario 400 of FIG. 4A, FD is enabled for the UE1 402, but not for the base stations 404-1, 404-2. A second full-duplex scenario 410 depicted in FIG. 4B includes two UEs, shown as UE1 402-1 and UE2 402-2, and a base station 404, where the UE1 402-1 is receiving a downlink transmission from the base station 404 and the UE2 402-2 is transmitting an uplink transmission to the base station 404. In the second full-duplex scenario 410, FD is enabled for the base station 404, but not for UE1 402-1 and UE2 402-2. A third full-duplex scenario 420 is depicted in FIG. 4C that includes a UE1 402 and a base station 404, where the UE1 402 is receiving a downlink transmission from the base station 404 and the UE1 402 is transmitting an uplink transmission to the base station 404. In the third full-duplex scenario 420, FD is enabled for both the UE1 402 and the base station 404.

As indicated above, FIGS. 4A-4C provide some examples. Other examples may differ from what is described with regard to FIGS. 4A-4C.

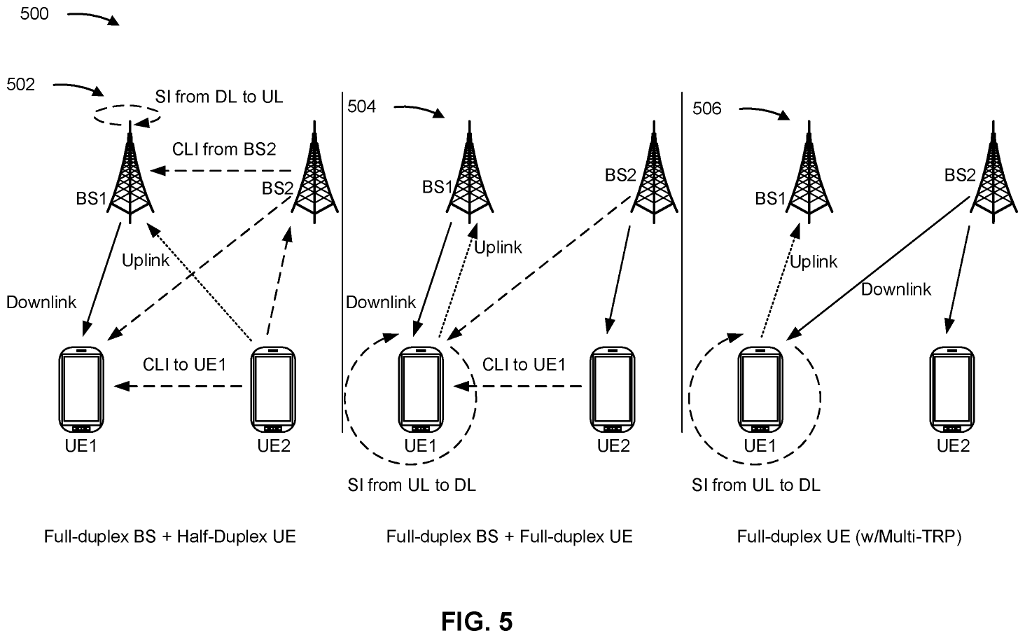

FIG. 5 is a diagram illustrating an example of full-duplex communication modes 500, in accordance with the present disclosure. In a first mode 502, a first network entity (shown as BS1) and a second network entity (shown as BS2) may be full-duplex devices (e.g., may be capable of communicating in a full-duplex manner). A first UE and a second UE may be half duplex UEs (e.g., may not be capable of communicating in a full-duplex manner). The first network entity may perform downlink transmissions to the first UE, and the first network entity may receive uplink transmissions from the second UE. The first network entity may experience SI from a downlink to an uplink based at least in part on the downlink transmissions to the first UE and the uplink transmissions received from the second UE. The first network entity may experience CLI from the second network entity. The first UE may experience CLI from the second network entity and the second UE.

In a second mode 504, a first network entity and a second network entity may be full-duplex devices. A first UE and a second UE may be full-duplex UEs. The first network entity may perform downlink transmissions to the first UE, and the first network entity may receive uplink transmissions from the first UE. The first UE may experience SI from an uplink to a downlink based at least in part on the downlink transmissions from the first network entity and the uplink transmissions to the first network entity. The first UE may experience CLI from the second network entity and the second UE.

In a third mode 506, a first UE and a second UE may be full-duplex UEs and may communicate in a multi-TRP configuration. A first network entity may receive uplink transmissions from the first UE, and a second network entity may perform downlink transmissions to the first UE and the second UE. The first UE may experience SI from an uplink to a downlink based at least in part on the uplink transmissions to the first network entity and the downlink transmissions from the second network entity.

As indicated above, FIG. 5 is provided as an example. Other examples may differ from what is described with regard to FIG. 5.

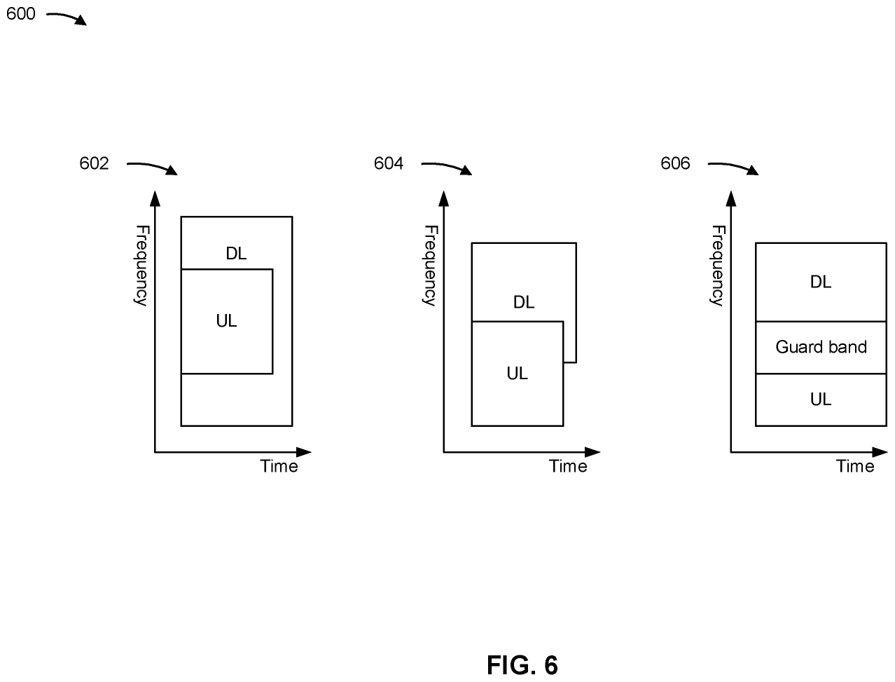

FIG. 6 is a diagram illustrating examples of full-duplex communication 600, in accordance with the present disclosure. In some cases, a wireless communication device (such as a UE or a network entity) may support full-duplex operations. Full-duplex operations may include the wireless communication device transmitting and receiving at approximately the same time.

A UE may operate in an in-band full-duplex mode. In the in-band full-duplex mode, the UE may transmit and receive on a same time and frequency resource. An uplink and a downlink may share the same time and frequency resource. For example, in a first full-duplex communication 602, a time and frequency resource for the uplink may fully overlap with a time and frequency resource for the downlink. As another example, in a second full-duplex communication 604, a time and frequency resource for the uplink may partially overlap with a time and frequency resource for the downlink.

Full-duplex operations may include a subband full-duplex (SBFD) mode. The SBFD mode may also be referred to as a subband frequency division duplex mode or a flexible duplex mode. SBFD communication 606 shows that the wireless communication device may transmit and receive at a same time (in the same SBFD slot), but the wireless communication device may transmit and receive on different frequency domain resources. For example, a network entity may be operating in an SBFD mode. The network entity may schedule a first UE to receive a downlink communication in an SBFD slot. The network entity may schedule a second UE to transmit an uplink communication in the same SBFD slot. However, the uplink communication may cause interference for the first UE that is receiving the downlink communication. To address this, a downlink time/frequency resource in the SBFD slot may be separated (e.g., in time or frequency) from an uplink time/frequency resource in the SBFD slot by a gap, which may function to reduce self-interference and improve latency and uplink coverage. The gap may be a frequency offset or a frequency gap (guard band) between downlink time/frequency resources and uplink time/frequency resources in the same SBFD slot. In some cases, a slot pattern may include a combination of downlink slots, uplink slots, or SBFD slots.

If a UE is operating in half-duplex mode and a network entity (e.g., gNB) is operating in SBFD or inter-band FD (IBFD), there may be multiple sources of interference at the UE. Such interference may include inter-cell interference from other network entities, intra-cell CLI from UEs in the same cell, and/or inter-cell CLI from UEs in adjacent cells. There may also be SI for full-duplex UEs.

Some uplink traffic models have periodic patterns, and victim UEs (UEs experiencing interference) may experience CLI or SI with periodic patterns. To obtain accurate semi-static interference measurements, a network entity may configure the victim UE to report CLI via an uplink MAC CE, which may be considered Layer 2 (L2) reporting. The network entity may configure an aggressor UE (UE causing interference for victim UE) with a semi-persistent (SP) or periodic sounding reference signal (SRS) resource set. An SP SRS may be activated or deactivated via a MAC CE and indicate a transmit power, such as a maximum power (e.g., P_{cmax}). The network entity may configure a victim UE with SP channel state information (CSI) interference measurement (CSI-IM) resources, which are activated or deactivated via MAC CE. CLI may be measured by the victim UE as a function of transmit power and coupling loss. If the coupling loss is known, the victim UE may estimate CLI for different transmit powers.

In some examples, L2 event-based CLI reporting may include periodic victim reports with one or more CLI values. A CLI value may include an indication of an amount of CLI interference, such as a decibel (dB) value or a dB milliwatt (dBm) value). The CLI value may be an indication of a CLI measurement, such as an RSRP, an RSSI, or a signal-to-noise-plus-interference ratio (SINR). The reporting may be based on triggering events, such as movement of the UE or activation or deactivation of communications by nearby UEs or network entities. The UE may transmit a MAC CE for triggering CSI-IM and CLI reporting. Other UEs or network entities may indicate CLI values as part of CLI reciprocity.

As indicated above, FIG. 6 is provided as an example. Other examples may differ from what is described with regard to FIG. 6.

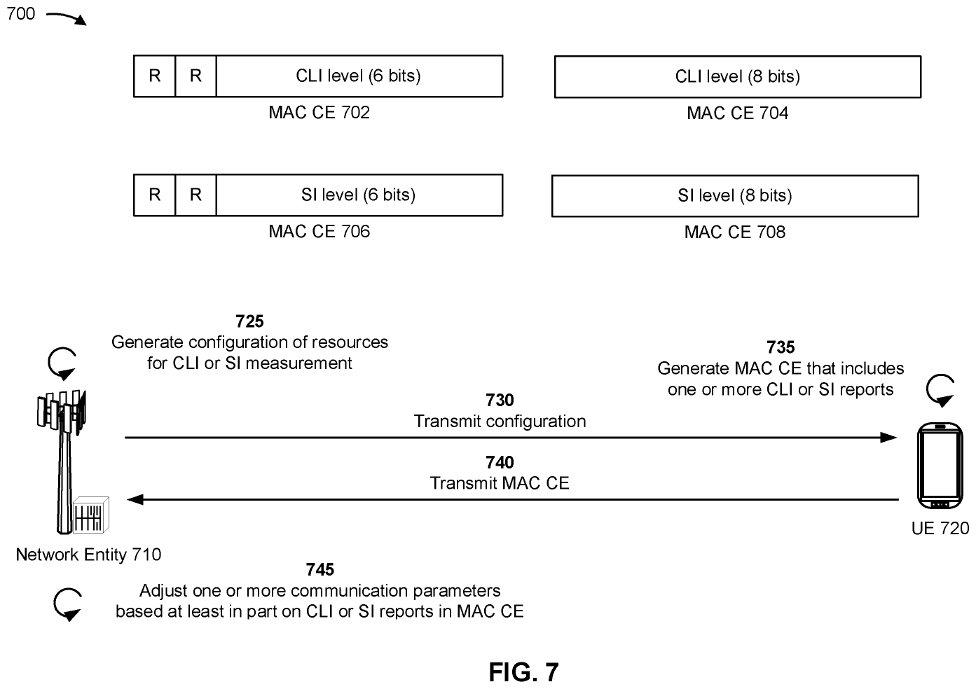

FIG. 7 is a diagram illustrating an example 700 of CLI or SI reporting, in accordance with the present disclosure. A network entity 710 (e.g., base station 110) and a UE 720 (e.g., UE 120) may communicate with each other via a wireless network (e.g., wireless network 100).

According to various aspects described herein, the UE 720 may transmit a MAC CE that includes one or more reports of CLI or SI at the UE 720. A report may include a CLI value. For example, a CLI value may include a CLI level that is based at least in part on a CLI measurement (e.g., RSRP, RSSI, SINR) of a CLI resource (e.g., reference signal, communication). The CLI level may be indicated using one or more bits. The MAC CE may follow one of a various quantity of structures for conveying CLI levels. A MAC CE may also be used to report SI levels, similar to the reporting of CLI levels. The MAC CE for CLI or SI may be designed to provide information while conserving overhead and signaling resources. MAC CE 702 through MAC CE 708 shows possible MAC CE designs. Other MAC CE designs are described below in connection with other figures.

In some aspects, the UE 720 may quantize a CLI measurement before reporting. For example, the CLI level may be a quantized value of a CLI measurement, an average of CLI measurements, a maximum of CLI measurements, a minimum of CLI measurements, or another value associated with CLI. In one option for reporting, as shown by MAC CE 702, a CLI measurement may be quantized into 6 bits. There may be other reserved bits in an octet of 8 bits. In another option, the CLI measurement may be quantized into a different quantity of bits, such as 7 bits for a base measurement and 4 bits for a differential measurement (difference between current measurement and base measurement). As yet another option, as shown by MAC CE 704, the CLI measurement may be quantized into, for example, 8 bits with no reserved bits.

A MAC CE may be designed to include a report of an SI value. Similar to CLI values, SI values may indicate SI measurements. The SI values may be quantized SI measurements. A MAC CE, for example, may include a quantity of bits for the SI value. MAC CE 706 shows 6 bits, and MAC CE 708 shows 8 bits.

Example 700 shows the reporting of CLI or SI in a designed MAC CE. As shown by reference number 725, the network entity 710 may generate a configuration of resource for CLI or SI measurement. Such resources may identify reference signals. The resources may also indicate time and/or frequency resources for measurement. As shown by reference number 730, the network entity 710 may transmit the configuration.

As shown by reference number 735, the UE 720 may generate a MAC CE that includes one or more CLI or SI reports. The CLI or SI reports may be based at least in part on CLI or SI measurements using the configured resources for CLI or SI measurement. As shown by reference number 740, the UE 720 may transmit the MAC CE. Both the network entity 710 and the UE 720 may be aware of a MAC CE design (e.g., UE 720 configured by network entity 710, UE 720 having stored configuration information specifying a MAC CE design).

As shown by reference number 745, the network entity 710 may adjust one or more communication parameters based at least in part on the CLI or SI reports included in the MAC CE. Adjusting communication parameters may include increasing or decreasing a transmit power. Adjusting communication parameters may also include changing a time and/or frequency for communications or other actions to mitigate reported CLI or SI interference. As a result, latency is reduced, communications are improved, and processing resources and signaling resources are conserved.

As indicated above, FIG. 7 is provided as an example. Other examples may differ from what is described with regard to FIG. 7.

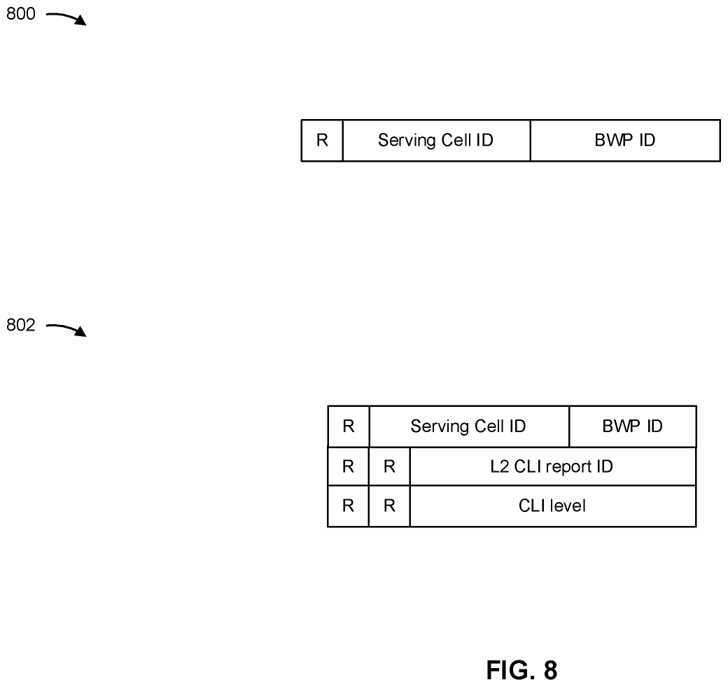

FIG. 8 is a diagram illustrating examples 800 and 802 of MAC CE designs, in accordance with the present disclosure.

In some aspects, CLI or SI reporting may be configured per bandwidth part (BWP). An L2 CLI or SI reporting radio resource control (RRC) configuration information element (IE) may be included with a BWP configuration. In some aspects, CLI or SI reporting may be configured per cell. An L2 CLI reporting RRC configuration IE may be included with a cell configuration. A MAC CE payload may include a BWP identifier (ID) and/or a serving cell ID, as shown by example 800.

Example 802 shows a MAC CE with a serving cell ID, a BWP ID, and an L2 CLI report ID to identify a CLI report. The CLI report may include a CLI level. In some aspects, a MAC CE may include only a single CLI level for one CLI report. The MAC CE may have a fixed payload size. Similar MAC CE designs may apply to SI values.

As indicated above, FIG. 8 is provides some examples. Other examples may differ from what is described with regard to FIG. 8.

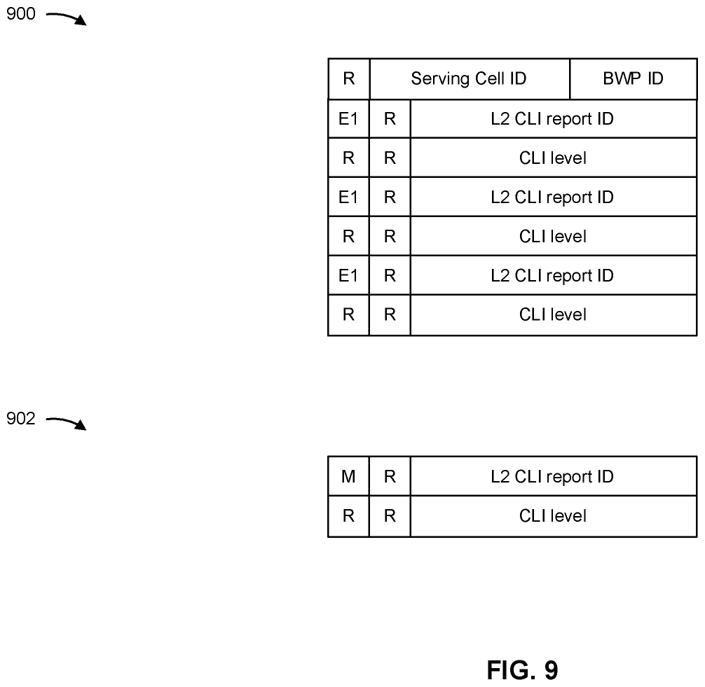

FIG. 9 is a diagram illustrating examples 900 and 902 of MAC CE designs, in accordance with the present disclosure.

In some aspects, a MAC CE may include more than one report for CLI or SI. Example 900 shows each of multiple CLI reports including a CLI report ID and a CLI level. The MAC CE may have a variable payload size. The payload size may vary according to the quantity of reports in the MAC CE. The MAC CE may include an extension bit (E1) to indicate whether a following octet includes a CLI report ID for another CLI report. There may be multiple extension bits if there are more than two reports. The UE 720 may not always report all configured CLI report IDs. The UE 720 may report a subset of CLI report IDs or indicate multiple CLI report IDs.

Example 902 shows a MAC CE with a fixed payload size. One of the reserved bits may be replaced with a field (M=1) that indicates if the report is based on a measured CLI. For example, if M=0, the network entity 710 may ignore the report. Similar MAC CE designs may apply to SI values.

As indicated above, FIG. 9 is provided as an example. Other examples may differ from what is described with regard to FIG. 9.

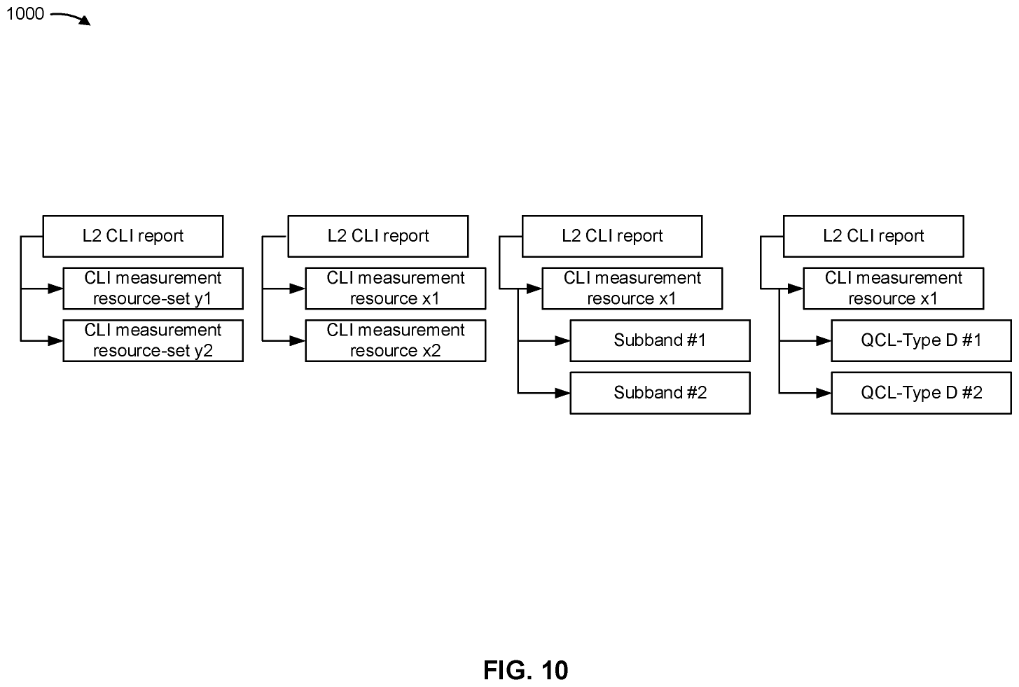

FIG. 10 is a diagram illustrating an example 1000 of measurement resources, in accordance with the present disclosure.

In some aspects, a MAC CE may include CLI or SI resource information for a CLI value of a report. One or more CLI values may correspond to different CLI measurement resources or resource sets (sets of measurement resources) associated with the same CLI report. There may be different subband measurements if subband CLI reporting is configured. Subbands may be associated with a sequence-index. There may also be different quasi-co-location (QCL) types for a CLI measurement resource. QCL types may correspond to transmission configuration indicator (TCI) states and spatial relations for beams or beam pairs used for communication. One QCL type may be QCL-Type D, which is associated with spatial relation parameters for reception by a UE. The UE may use different QCL-Type D parameters for CLI measurement resources. QCL-Type D information or TCI-states may be associated with a sequence-index. Example 1000 shows different types of information that may be indicated in a report, including CLI resource information, CLI resource set information, subbands, or QCL-Type Ds. Similar designs may apply to SI values.

As indicated above, FIG. 10 is provided as an example. Other examples may differ from what is described with regard to FIG. 10.

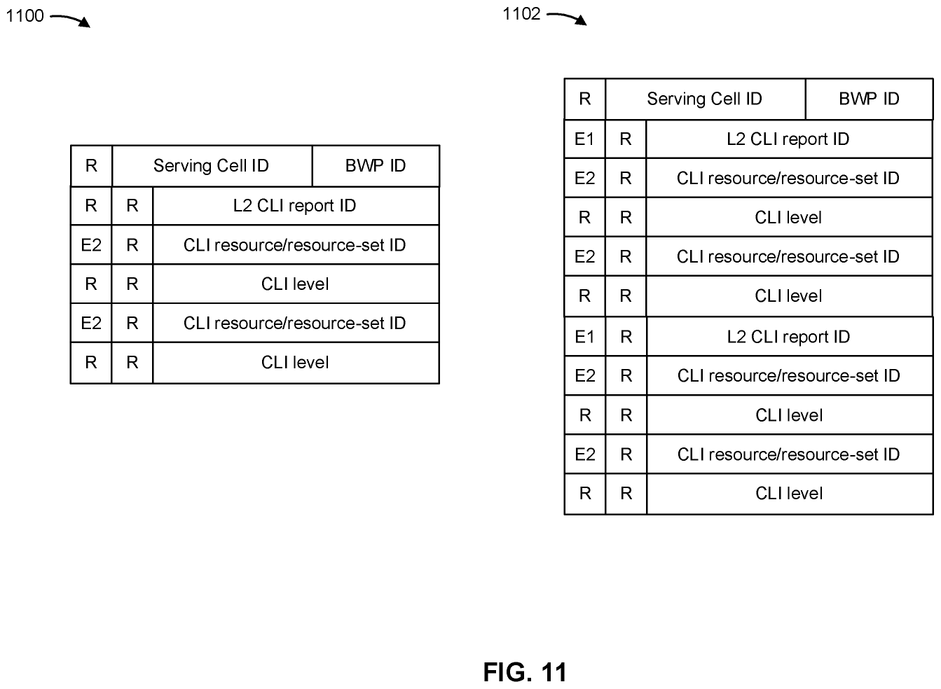

FIG. 11 is a diagram illustrating examples 1100 and 1102 of MAC CE designs, in accordance with the present disclosure.

In some aspects, the MAC CE may indicate CLI resources or CLI resource sets. Example 1100 shows a MAC CE with only one CLI report, but with a CLI level for each of multiple CLI resource IDs or CLI resource set IDs. The MAC CE may have a variable payload size. This MAC CE design may be applicable when a subset of CLI resources associated with a report are measured and/or activated. The MAC CE may include an extension bit (E2) to indicate whether there are following octets of additional CLI resources or resource sets to be reported. Alternatively, the MAC CE may have a fixed payload size that may be applicable if the quantity of CLI values to be included in a CLI report is fixed by configuration. For example, the UE may indicate a specified quantity of subbands in the report. Similar designs may be used for reporting multiple subbands or QCL-Type Ds and for reporting SI values.

Example 1102 shows a MAC CE that includes one or more reports. In some aspects, a payload for a single report may be fixed and a total payload may be variable based on the quantity of reports in the MAC CE. Alternatively, in some aspects, a payload for a single report may be variable and the total payload may also be variable (using extension bits). Similar MAC CE designs may apply to SI values.

As indicated above, FIG. 11 is provided as an example. Other examples may differ from what is described with regard to FIG. 11.

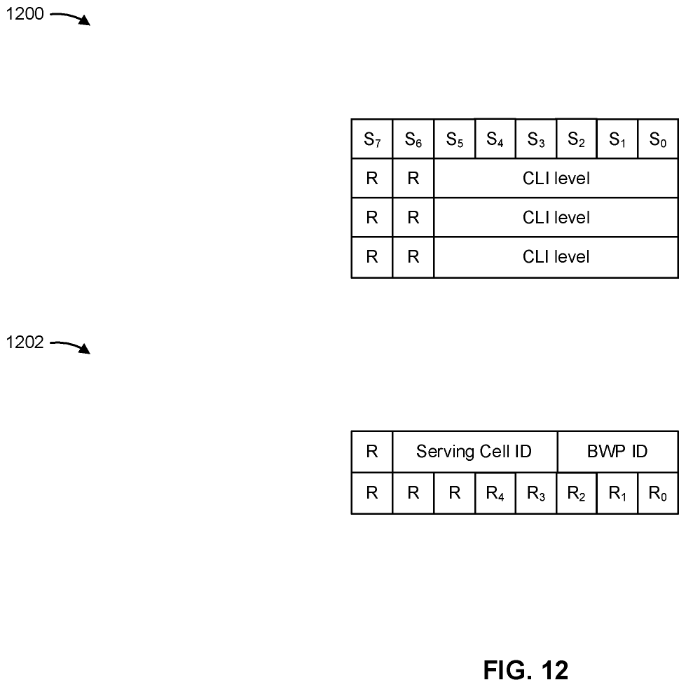

FIG. 12 is a diagram illustrating examples 1200 and 1202 of MAC CE designs, in accordance with the present disclosure.

In some aspects, a UE may indicate a CLI report ID using a bitmap instead of using an explicit CLI report ID. This may help to reduce signaling overhead. Each bit (Sᵢ) may represent a CLI report ID from a list of configured L2 CLI report IDs. Sᵢ may represent the (i+1)th CLI report ID in the list (reports are ordered by ID). Example 1200 shows a MAC CE that includes a bitmap with multiple CLI levels. The UE may report a quantity of CLI levels for each CLI report ID based at least in part on the RRC configuration (e.g., different subbands or QCL-Type Ds). A subset of CLI measurement values of one CLI report ID may not be applicable in this case.

In some aspects, a MAC CE may use threshold values for reporting. This may reduce signaling overhead. Example 1202 shows multiple bits for a UE configured with one or more thresholds for CLI. In some aspects, each CLI report is represented by one bit. A bit value of 0 may indicate a CLI level below a CLI threshold (or not measured), and a bit value of 1 may indicate a CLI level above the CLI threshold. A MAC CE may include fields for all configured reports (active/inactive) or only for active reports. The reports may be ordered by ID. In some aspects, a CLI report may be represented by two bits. For examples, a bit value of 0 indicates that a CLI is not measured, a bit value of 1 indicates a measured CLI less than a first CLI threshold (low CLI), a bit value of 2 indicates a measured CLI between the first CLI threshold and a second CLI threshold (medium CLI), and a bit value of 3 indicates a measured CLI that is greater than the second threshold (high CLI). Similar thresholds may apply to SI values.

As indicated above, FIG. 12 is provided as an example. Other examples may differ from what is described with regard to FIG. 12.

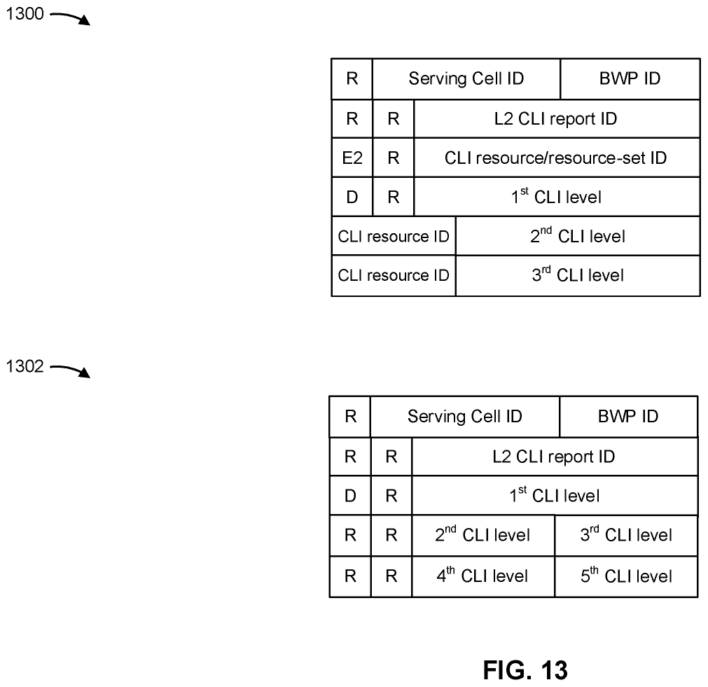

FIG. 13 is a diagram illustrating examples 1300 and 1302 of MAC CE designs, in accordance with the present disclosure.

In some aspects, a MAC CE may include a report with multiple CLI metrics. Example 1300 shows a MAC CE with multiple CLI metrics that are associated with the same report. In some aspects, a report may include a value field for a resource/resource-set ID and CLI value fields for CLI levels. A CLI value field and a CLI resource/resource-set ID value field may be in one octet to save more octets if the length of these two fields could include fewer bits (e.g., 5 bits for a CLI value and 3 bits for a CLI resource ID). A bit (D) may indicate differential reporting. The interpretation of the 5^{th} and remaining octets will be different based on the D bit indicator.

Example 1302 shows a report with a fixed quantity of CLI levels that include one base value. All remaining values may be differential. For example, a base CLI level may be indicated by 6 bits and each differential CLI level (2^{nd} through 5^{th}) may be indicated by 3 bits. This MAC CE design may be applicable if the quantity of CLI levels to be reported is fixed by configuration (e.g., quantity of subbands, quantity of QCL-TypeDs to be reported).

As indicated above, FIG. 13 is provided as an example. Other examples may differ from what is described with regard to FIG. 13.

FIG. 14 is a diagram illustrating an example process 1400 performed, for example, by a UE, in accordance with the present disclosure. Example process 1400 is an example where the UE (e.g., UE 120, UE 720) performs operations associated with using a MAC CE to report CLI or SI.

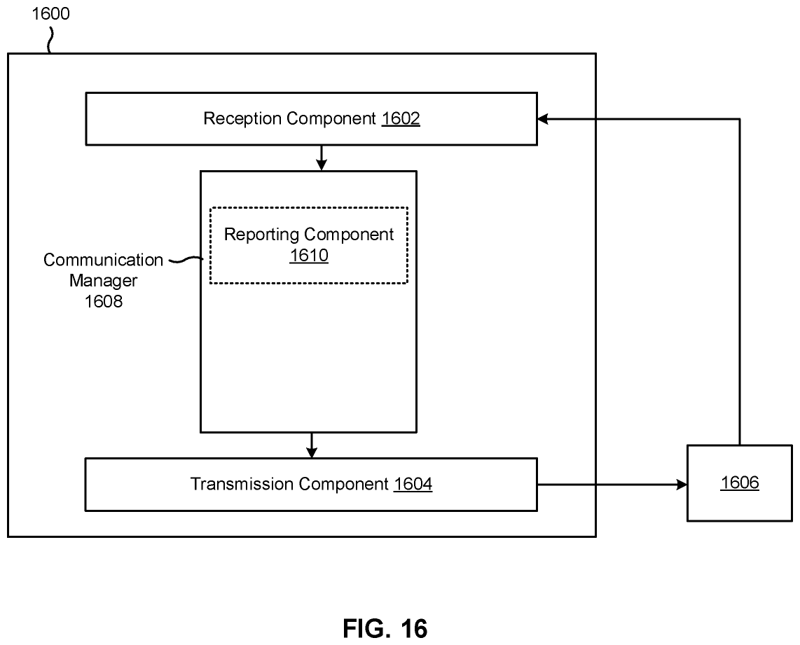

As shown in FIG. 14, in some aspects, process 1400 may include generating a MAC CE that includes one or more reports that each indicate one or more CLI or SI values (block 1410). For example, the UE (e.g., using communication manager 1608 and/or reporting component 1610 depicted in FIG. 16 may generate a MAC CE that includes one or more reports that each indicate one or more CLI or SI values, as described above.

As further shown in FIG. 14, in some aspects, process 1400 may include transmitting the MAC CE (block 1420). For example, the UE (e.g., using communication manager 1608 and/or transmission component 1604 depicted in FIG. 16) may transmit the MAC CE, as described above.

Process 1400 may include additional aspects, such as any single aspect or any combination of aspects described below and/or in connection with one or more other processes described elsewhere herein.

In a first aspect, generating the one or more reports includes measuring CLI or SI using one or more resources or resource sets.

In a second aspect, alone or in combination with the first aspect, generating the one or more reports includes quantizing a CLI or SI measurement into a quantity of bits.

In a third aspect, alone or in combination with one or more of the first and second aspects, the MAC CE indicates a serving cell ID.

In a fourth aspect, alone or in combination with one or more of the first through third aspects, the MAC CE indicates a bandwidth part ID.

In a fifth aspect, alone or in combination with one or more of the first through fourth aspects, the MAC CE indicates a CLI or SI report identifier and a CLI or SI value for each report of the one or more reports.

In a sixth aspect, alone or in combination with one or more of the first through fifth aspects, the MAC CE has a fixed payload size.

In a seventh aspect, alone or in combination with one or more of the first through sixth aspects, the MAC CE has a variable payload size that is based on a quantity of the one or more reports.

In an eighth aspect, alone or in combination with one or more of the first through seventh aspects, the MAC CE includes one or more extension bits to indicate the quantity of the one or more reports.

In a ninth aspect, alone or in combination with one or more of the first through eighth aspects, the MAC CE includes a report identifier and a CLI or SI value for each report of the quantity of the one or more reports.

In a tenth aspect, alone or in combination with one or more of the first through ninth aspects, the MAC CE includes a report identifier and a variable quantity of CLI or SI values for each report of the quantity of the one or more reports.

In an eleventh aspect, alone or in combination with one or more of the first through tenth aspects, the MAC CE includes a report identifier and multiple CLI or SI values for each report of the quantity of the one or more reports.

In a twelfth aspect, alone or in combination with one or more of the first through eleventh aspects, the MAC CE indicates a resource or resource set for each report of multiple reports of the one or more reports.

In a thirteenth aspect, alone or in combination with one or more of the first through twelfth aspects, the MAC CE indicates multiple resources or resource sets for each report of multiple reports of the one or more reports.

In a fourteenth aspect, alone or in combination with one or more of the first through thirteenth aspects, the multiple resources or resource sets include different subbands.

In a fifteenth aspect, alone or in combination with one or more of the first through fourteenth aspects, the multiple resources or resource sets are associated with different QCL-Type D states or different transmission configuration indicator states.

In a sixteenth aspect, alone or in combination with one or more of the first through fifteenth aspects, the MAC CE indicates a resource or resource set for each of multiple CLI or SI values for a report of the one or more reports.

In a seventeenth aspect, alone or in combination with one or more of the first through sixteenth aspects, the MAC CE includes a bitmap that indicates a report identifier.

In an eighteenth aspect, alone or in combination with one or more of the first through seventeenth aspects, the MAC CE includes multiple resources or resource sets and a CLI or SI value for each resource or resource set.

In a nineteenth aspect, alone or in combination with one or more of the first through eighteenth aspects, the MAC CE includes a base CLI or SI value and one or more differential CLI or SI values.

In a twentieth aspect, alone or in combination with one or more of the first through nineteenth aspects, the MAC CE includes a bit that indicates whether a CLI or SI measurement satisfies a threshold.

In a twenty-first aspect, alone or in combination with one or more of the first through twentieth aspects, the MAC CE includes multiple bits that indicate whether a CLI or SI measurement satisfies one or more thresholds.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network entity, in accordance with the present disclosure. Example process 1500 is an example where the network entity (e.g., base station 110, network entity 710) performs operations associated with using a MAC CE to report CLI or SI.

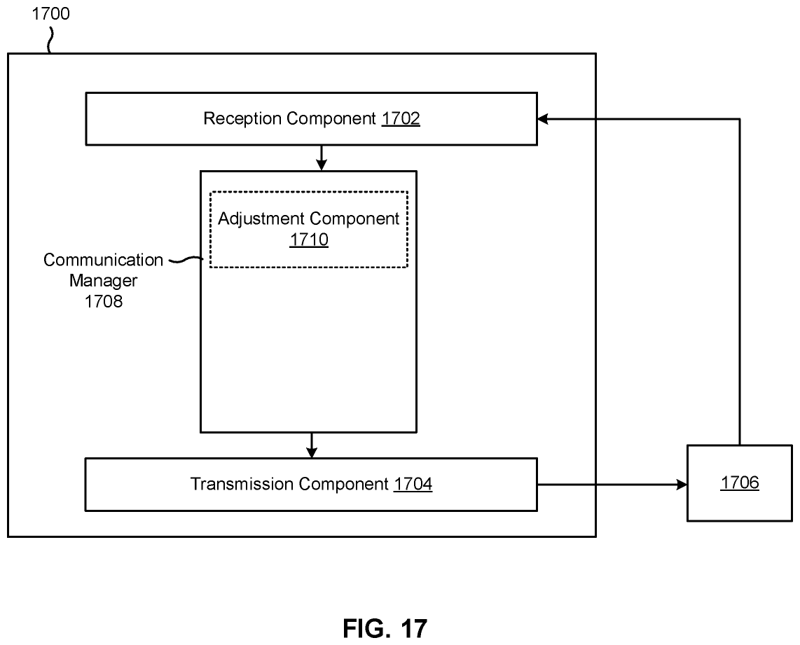

As shown in FIG. 15, in some aspects, process 1500 may include transmitting a configuration of resources for CLI or SI measurement (block 1510). For example, the network entity (e.g., using communication manager 1708 and/or transmission component 1704 depicted in FIG. 17) may transmit a configuration of resources for CLI or SI measurement, as described above.

As further shown in FIG. 15, in some aspects, process 1500 may include receiving a MAC CE that includes one or more reports that each indicate one or more CLI or SI values (block 1520). For example, the network entity (e.g., using communication manager 1708 and/or reception component 1702 depicted in FIG. 17) may receive a MAC CE that includes one or more reports that each indicate one or more CLI or SI values, as described above.

Process 1500 may include additional aspects, such as any single aspect or any combination of aspects described below and/or in connection with one or more other processes described elsewhere herein.

In a first aspect, process 1500 includes adjusting one or more communication parameters based at least in part on the one or more reports.

In a second aspect, alone or in combination with the first aspect, the MAC CE indicates a CLI or SI report identifier and a CLI or SI value for each report of the one or more reports.

In a third aspect, alone or in combination with one or more of the first and second aspects, the MAC CE has a variable payload size that is based on a quantity of the one or more reports.

In a fourth aspect, alone or in combination with one or more of the first through third aspects, the MAC CE indicates a resource or resource set for each of multiple CLI or SI values for a report of the one or more reports.

In a fifth aspect, alone or in combination with one or more of the first through fourth aspects, the MAC CE includes multiple resources or resource sets and a CLI or SI value for each resource or resource set.

In a sixth aspect, alone or in combination with one or more of the first through fifth aspects, the MAC CE includes a base CLI or SI value and one or more differential CLI or SI values.

In a seventh aspect, alone or in combination with one or more of the first through sixth aspects, the MAC CE includes a bit that indicates whether a CLI or SI measurement satisfies a threshold.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE (e.g., UE 120, UE 720), or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the UE described in connection with FIG. 2. The communication manager 1608 may be, or be similar to, the communication manager 140 depicted in FIGS. 1 and 2. For example, in some aspects, the communication manager 1608 may be configured to perform one or more of the functions described as being performed by the communication manager 140. In some aspects, the communication manager 1608 may include the reception component 1602 and/or the transmission component 1604. The communication manager 1608 may include a reporting component 1610, among other examples.

In some aspects, the apparatus 1600 may be configured to perform one or more operations described herein in connection with FIGS. 1-13. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The reporting component 1610 may generate a MAC CE that includes one or more reports that each indicate one or more CLI or SI values. The transmission component 1604 may transmit the MAC CE.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network entity (e.g., base station 110, network entity 710), or a network entity may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 1708. The communication manager 1708 may control and/or otherwise manage one or more operations of the reception component 1702 and/or the transmission component 1704. In some aspects, the communication manager 1708 may include one or more antennas, a modem, a controller/processor, a memory, or a combination thereof, of the network entity described in connection with FIG. 2. The communication manager 1708 may be, or be similar to, the communication manager 150 depicted in FIGS. 1 and 2. For example, in some aspects, the communication manager 1708 may be configured to perform one or more of the functions described as being performed by the communication manager 150. In some aspects, the communication manager 1708 may include the reception component 1702 and/or the transmission component 1704. The communication manager 1708 may include an adjustment component 1710, among other examples.

In some aspects, the apparatus 1700 may be configured to perform one or more operations described herein in connection with FIGS. 1-13. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the network entity described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network entity described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network entity described in connection with FIG. 2. In some aspects, the transmission component 1704 may be co-located with the reception component 1702 in a transceiver.

The transmission component 1704 may transmit a configuration of resources for CLI or SI measurement. The reception component 1702 may receive a MAC CE that includes one or more reports that each indicate one or more CLI or SI values. The adjustment component 1710 may adjust one or more communication parameters based at least in part on the one or more reports.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: generating a medium access control control element (MAC CE) that includes one or more reports that each indicate one or more cross-link interference (CLI) or self-interference (SI) values; and transmitting the MAC CE.

Aspect 2: The method of Aspect 1, wherein generating the one or more reports includes measuring CLI or SI using one or more resources or resource sets.

Aspect 3: The method of Aspect 1 or 2, wherein generating the one or more reports includes quantizing a CLI or SI measurement into a quantity of bits.

Aspect 4: The method of any of Aspects 1-3, wherein the MAC CE indicates a serving cell identifier (ID).

Aspect 5: The method of Aspect 4, wherein the MAC CE indicates a bandwidth part ID.

Aspect 6: The method of any of Aspects 1-5, wherein the MAC CE indicates a

CLI or SI report identifier and a CLI or SI value for each report of the one or more reports.

Aspect 7: The method of any of Aspects 1-6, wherein the MAC CE has a fixed payload size.

Aspect 8: The method of any of Aspects 1-6, wherein the MAC CE has a variable payload size that is based on a quantity of the one or more reports.

Aspect 9: The method of Aspect 8, wherein the MAC CE includes one or more extension bits to indicate the quantity of the one or more reports.

Aspect 10: The method of Aspect 8 or 9, wherein the MAC CE includes a report identifier and a CLI or SI value for each report of the quantity of the one or more reports.

Aspect 11: The method of Aspect 8 or 9, wherein the MAC CE includes a report identifier and a variable quantity of CLI or SI values for each report of the quantity of the one or more reports.

Aspect 12: The method of Aspect 8 or 9, wherein the MAC CE includes a report identifier and multiple CLI or SI values for each report of the quantity of the one or more reports.

Aspect 13: The method of any of Aspects 1-12, wherein the MAC CE indicates a resource or resource set for each report of multiple reports of the one or more reports.

Aspect 14: The method of any of Aspects 1-12, wherein the MAC CE indicates multiple resources or resource sets for each report of multiple reports of the one or more reports.

Aspect 15: The method of Aspect 14, wherein the multiple resources or resource sets include different subbands.

Aspect 16: The method of Aspect 14 or 15, wherein the multiple resources or resource sets are associated with different quasi-co-location Type D states or different transmission configuration indicator states.

Aspect 17: The method of Aspect 16, wherein the MAC CE indicates a resource or resource set for each of multiple CLI or SI values for a report of the one or more reports.

Aspect 18: The method of any of Aspects 1-17, wherein the MAC CE includes a bitmap that indicates a report identifier.

Aspect 19: The method of any of Aspects 1-18, wherein the MAC CE includes multiple resources or resource sets and a CLI or SI value for each resource or resource set.

Aspect 20: The method of any of Aspects 1-19, wherein the MAC CE includes a base CLI or SI value and one or more differential CLI or SI values.

Aspect 21: The method of any of Aspects 1-20, wherein the MAC CE includes a bit that indicates whether a CLI or SI measurement satisfies a threshold.

Aspect 22: The method of any of Aspects 1-21, wherein the MAC CE includes multiple bits that indicate whether a CLI or SI measurement satisfies one or more thresholds.

Aspect 23: A method of wireless communication performed by a network entity, comprising: transmitting a configuration of resources for cross-link interference (CLI) or self-interference (SI) measurement; and receiving a medium access control control element (MAC CE) that includes one or more reports that each indicate one or more CLI or SI values.

Aspect 24: The method of Aspect 23, further comprising adjusting one or more communication parameters based at least in part on the one or more reports.

Aspect 25: The method of Aspect 23 or 24, wherein the MAC CE indicates a CLI or SI report identifier and a CLI or SI value for each report of the one or more reports.

Aspect 26: The method of any of Aspects 23-25, wherein the MAC CE has a variable payload size that is based on a quantity of the one or more reports.

Aspect 27: The method of any of Aspects 23-26 wherein the MAC CE indicates a resource or resource set for each of multiple CLI or SI values for a report of the one or more reports.

Aspect 28: The method of any of Aspects 23-27, wherein the MAC CE includes multiple resources or resource sets and a CLI or SI value for each resource or resource set.

Aspect 29: The method of any of Aspects 23-28, wherein the MAC CE includes a base CLI or SI value and one or more differential CLI or SI values.

Aspect 30: The method of any of Aspects 23-29, wherein the MAC CE includes a bit that indicates whether a CLI or SI measurement satisfies a threshold.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a 30 a+a, a+a+b, a+a+c, a+b+b, a +c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
generate a medium access control control element (MAC CE) that includes one or more reports that each indicate one or more cross-link interference (CLI) or self-interference (SI) values; and
transmit the MAC CE.

2. The UE of claim 1, wherein the one or more processors, to generate the one or more reports, are configured to measure CLI or SI using one or more resources or resource sets.

3. The UE of claim 1, wherein the one or more processors, to generate the one or more reports, are configured to quantize a CLI or SI measurement into a quantity of bits.

4. The UE of claim 1, wherein the MAC CE indicates a serving cell identifier (ID).

5. The UE of claim 4, wherein the MAC CE indicates a bandwidth part ID.

6. The UE of claim 1, wherein the MAC CE indicates a CLI or SI report identifier and a CLI or SI value for each report of the one or more reports.

7. The UE of claim 1, wherein the MAC CE has a fixed payload size.

8. The UE of claim 1, wherein the MAC CE has a variable payload size that is based on a quantity of the one or more reports.

9. The UE of claim 8, wherein the MAC CE includes one or more extension bits to indicate the quantity of the one or more reports.

10. The UE of claim 8, wherein the MAC CE includes a report identifier and a CLI or SI value for each report of the quantity of the one or more reports.

11. The UE of claim 8, wherein the MAC CE includes a report identifier and a variable quantity of CLI or SI values for each report of the quantity of the one or more reports.

12. The UE of claim 8, wherein the MAC CE includes a report identifier and multiple CLI or SI values for each report of the quantity of the one or more reports.

13. The UE of claim 1, wherein the MAC CE indicates a resource or resource set for each report of multiple reports of the one or more reports.

14. The UE of claim 1, wherein the MAC CE indicates multiple resources or resource sets for each report of multiple reports of the one or more reports.

15. The UE of claim 14, wherein the multiple resources or resource sets include different subbands.

16. The UE of claim 14, wherein the multiple resources or resource sets are associated with different quasi-co-location Type D states or different transmission configuration indicator states.

17. The UE of claim 16, wherein the MAC CE indicates a resource or resource set for each of multiple CLI or SI values for a report of the one or more reports.

18. The UE of claim 1, wherein the MAC CE includes a bitmap that indicates a report identifier.

19. The UE of claim 1, wherein the MAC CE includes multiple resources or resource sets and a CLI or SI value for each resource or resource set.

20. The UE of claim 1, wherein the MAC CE includes a base CLI or SI value and one or more differential CLI or SI values.

21. The UE of claim 1, wherein the MAC CE includes a bit that indicates whether a CLI or SI measurement satisfies a threshold.

22. The UE of claim 1, wherein the MAC CE includes multiple bits that indicate whether a CLI or SI measurement satisfies one or more thresholds.

23. A network entity for wireless communication, comprising:
a memory; and
one or more processors, coupled to the memory, configured to:
transmit a configuration of resources for cross-link interference (CLI) or self-interference (SI) measurement; and
receive a medium access control control element (MAC CE) that includes one or more reports that each indicate one or more CLI or SI values.

24. The network entity of claim 23, wherein the one or more processors are configured to adjust one or more communication parameters based at least in part on the one or more reports.

25. The network entity of claim 23, wherein the MAC CE indicates a CLI or SI report identifier and a CLI or SI value for each report of the one or more reports.

26. The network entity of claim 23, wherein the MAC CE has a variable payload size that is based on a quantity of the one or more reports.

27. The network entity of claim 23, wherein the MAC CE indicates a resource or resource set for each of multiple CLI or SI values for a report of the one or more reports.

28. The network entity of claim 23, wherein the MAC CE includes multiple resources or resource sets and a CLI or SI value for each resource or resource set.

29. The network entity of claim 23, wherein the MAC CE includes a base CLI or SI value and one or more differential CLI or SI values.

30. The network entity of claim 23, wherein the MAC CE includes a bit that indicates whether a CLI or SI measurement satisfies a threshold.
